(19) United States
(12) Patent Application Publication
(10) Pub. No.: US 2016/0127134 A1
(43) Pub. Date: May 5, 2016

(54) USER AUTHENTICATION SYSTEM AND METHOD

(71) Applicant: BARCLAYS BANK PLC, London, Greater London (GB)

(72) Inventors: Jeremy GOLDSTONE, Greater Manchester (GB); Timothy PORTER, Cheshire (GB)

(21) Appl. No.: 14/893,881

(22) PCT Filed: May 23, 2014
(86) PCT No.: PCT/GB2014/051590

§ 371 Date: Nov. 24, 2015

(30) Foreign Application Priority Data
May 24, 2013 (GB) 1309418.0

(51) Int. Cl. H04L 9/32

(52) U.S. Cl. CPC H04L 9/3271; H04L 9/3226

(57) ABSTRACT

A computer-implemented method and system are provided for authenticating the identity of a user registered with a computer system. The authentication method comprises generating a multi-dimensional array of elements that are addressable by respective sets of indices, generating a challenge code comprising a linear array of elements for addressing a first set of indices of the array of elements, transmitting the multi-dimensional array of elements and challenge code to at least one computing device associated with the user, receiving a response code from the user, and verifying the user's identity when the received response code matches a derived code obtained by retrieving elements from the multi-dimensional array at locations addressed by elements taken from the challenge code and a personal code stored at the computer system, wherein the personal code comprises a linear array of elements for addressing a different set of indices of the array of elements.

### FIELD OF THE INVENTION

This invention relates to a user authentication system, and more particularly to an improved system and method for verifying the identity of a user.

### BACKGROUND OF THE INVENTION

Online transaction systems are widely available, in which a user is registered with a service provider for secure access to associated products and services from a computing device over a data network communications link. For example, it is commonly known for secure systems to provide various financial transaction based services, such as online banking, peer to peer (P2P) financial transactions, online shopping, mobile wallet payments, etc. In such systems, secure identification and verification of the user and/or device is vital to prevent fraudulent financial transactions.

Secure user authentication is also important in systems providing products and services to registered users whereby the online transactions are not necessarily financial in nature, such as registration with the system for access to the products and services, online account management for registered services, online database access, remote system log-in, etc. In such systems, it is just as important to securely verify the identity of a registered user before enabling access to the provided products and services.

Conventional authentication systems may employ a two-factor authentication approach, requiring the presentation of two authentication factors: a knowledge factor, which is something the user knows, and a possession factor, which is something the user has. Typically, the knowledge factor may be in the form of a user's confidential Personal Identity Number (PIN), known only to the user and stored securely in the host system. The possession factor may be in the form of the user's mobile handset as a token device using SMS messaging, an interactive telephone call or via a mobile application installed on a smartphone.

Various implementations of such two-factor, two-channel authentication systems are known. For example, EP1316076 (Swivel Technologies Ltd) discusses a method and system for secure identification of a person in an electronic communications environment, wherein a host computer is adapted to be able to communicate with a plurality of electronic devices operated by the user. The user is issued with a user code, such as a PIN, known only to the user and stored in the host computer. When the user is required to identify themselves to the host computer, the host computer generates a pseudo-random security string and applies the user code to the pseudo-random security string to generate a transaction code. The host computer also transmits the pseudo-random security string to one of the electronic devices which is displayed by the electronic device to the user. The user applies their known user code to the displayed pseudo-random security string and determines the transaction code. Positive identification is achieved when the host computer determined transaction code matches the transaction code entered by the user.

GB2488310 (Winfrasoft Corp) discusses a method for authenticating a user of a computerised system comprising computing an array or grid of elements, presenting the array to the user, receiving user input comprising elements corresponding to pre-determined positions within the array, comparing the user input against a known value and authenticating a user if there is a match. The user input forms a one-time password (OTP) where the pre-determined positions are defined by a memorable identification pattern that is not received by the authentication device.

EP1676393 (Grid Data Security) and EP2084622 (Sypherlock Technology Corp) discusses a user authentication method that includes creating an authentication key in the form of a user formula, presenting a user with an arrangement of variables, each assigned a value, applying the assigned values to matching variables in the user formula and calculating a first result, and authenticating the user if the first result matches a second result of a separate and independent calculation of the user formula.

EP1964078 (Gridlockts Limited) discusses a method for verifying a person's identity which comprises presenting to the person a challenge grid of locations occupied by a pseudo-random set of symbols, and challenging the person to identify a response set of symbols occupying locations in the challenge grid corresponding to the stored personal pattern.

However, conventional authentication systems are continually under threat of circumvention and/or unauthorized access via fraudulent activity, such as mobile Trojan passcode theft, stolen phones, churned numerical codes, unauthorized registrations, etc.

What is desired is a more robust authentication system and method that provides increased security measures to address the risks from such potential fraudulent activity.

### Statements of the Invention

Aspects of the present invention are set out in the accompanying claims.

According to one aspect of the present invention, a method is provided of authenticating the identity of a user registered with a computer system, by storing data representative of a personal code associated with the registered user; generating a multi-dimensional array of elements that are addressable by respective sets of indices, generating a challenge code comprising a linear array of elements for addressing a first set of indices of the array of elements, transmitting the generated multi-dimensional array of elements and challenge code to at least one computing device associated with the user, receiving a response code from the user, and verifying the user's identity when the received response code matches a derived code obtained by retrieving elements from the multi-dimensional array at locations addressed by elements taken from the challenge code and a personal code stored at the computer system, wherein the personal code comprises a linear array of elements for addressing a different set of indices of the array of elements; and authenticating the identity of the user when the response code matches the derived code.

In another aspect, the present invention provides a method for authenticating the identity of a user associated with a mobile handset at a host computer, the method comprising generating and transmitting a security code and a challenge code to the user, the security code comprising a multi-dimensional array of code elements and the challenge code defining a plurality of elements for addressing the array of code elements along a first axis; and receiving and verifying a response code from the user, by matching the response code to a code derived by the host computer based on the generated security code and challenge code in combination with a personal code stored at the host computer, wherein each element of the challenge code is associated, in positional order, with an element of the personal code to define a respective set of coordinates to the multi-dimensional array of code elements for retrieving the elements of the derived code.

In yet another aspect, there is provided a system arranged to carry out the above method.

In other aspects, there is provided a computer program arranged to carry out the method when executed by suitable programmable devices

### BRIEF DESCRIPTION OF THE DRAWINGS

There now follows, by way of example only, a detailed description of embodiments of the present invention, with references to the figures identified below.

FIG. 1 is a block diagram showing the main components of an authentication system according to an embodiment of the invention.

FIG. 2, which comprises FIGS. 2a and 2b, is a flow diagram illustrating the main processing steps performed by main components of the authentication system of FIG. 1 according to an embodiment.

FIG. 3 is a schematic diagram illustrating an example of deriving a verification response code according to an embodiment.

FIG. 4 is a diagram of an example of a computer system on which one or more of the functions of the embodiment may be implemented.

### DETAILED DESCRIPTION OF EMBODIMENTS OF THE INVENTION

Overview

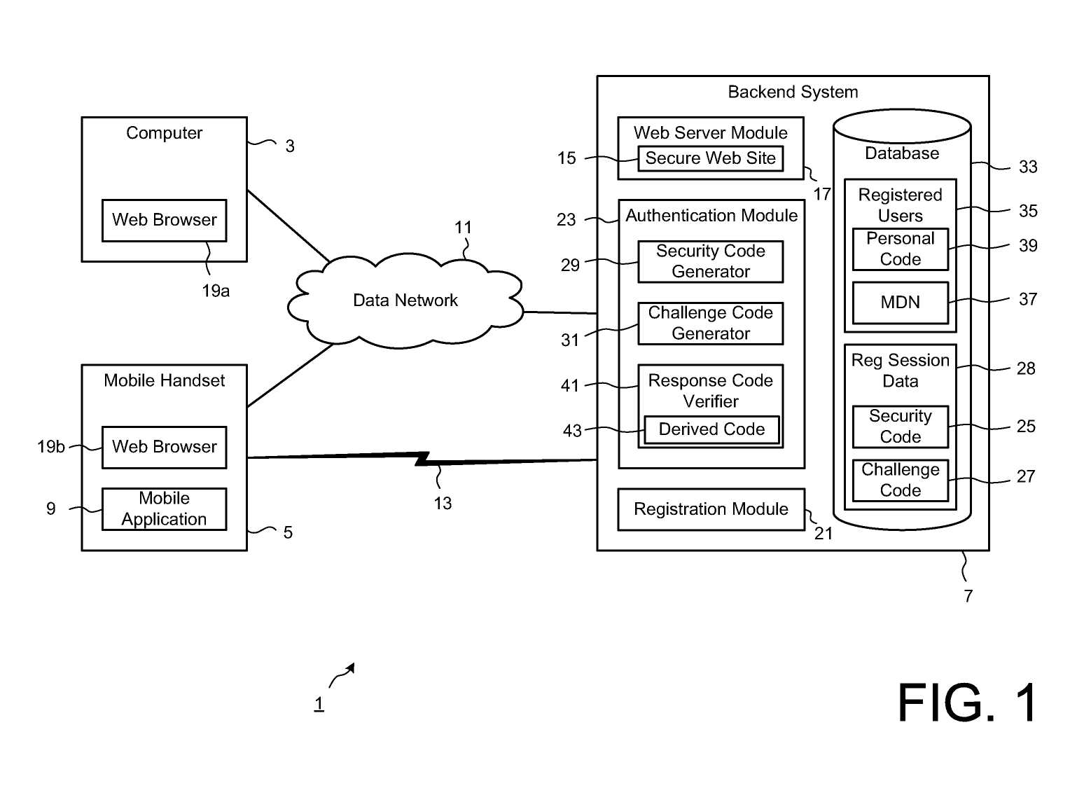

A specific embodiment of the invention will now be described for a process of authenticating the identity of a user within a system that provides products and services to registered users of the system. Referring to FIG. 1, an authentication system 1 according to an embodiment includes a computer 3 and a mobile handset 5 associated with a registered user of the backend system 7 that provides products and services to the mobile handset 5, for example via a mobile application 9 on the mobile handset 5 that is issued by the backend system 7.

The backend system 7 is in electronic communication with the computer 3 and the mobile handset 5 via a data network 11. The mobile handset 5 is also in electronic communication with the backend system 7 via a cellular communication network 13. It will be appreciated that in some network configurations, the cellular network communication path 13 will be through the data network 11.

The computer 3 may be any form of computing device or platform suitable to execute web browser software, such as a personal desktop or laptop computer, a personal data assistant (PDA), a smart phone, a tablet device, or the like. The mobile handset 5 can be a mobile smartphone, tablet computer, portable computing device, or the like. The data network 11 may be any suitable data communication network or combination of known networks, such as a wireless network, a local- or wide-area network including an intranet or the Internet, using for example the TCP/IP protocol, or a cellular communication network such as GPRS, EDGE or 3G, for example. Such communication protocols are of a type that are known per se in data networks and need not be described further. Electronic data communication by the computer 3, mobile handset 5 and backend system 7 can be encrypted.

In this exemplary embodiment, the backend system 7 is associated with a financial institution that provides online banking products and services to the users who have registered accounts with the financial institution via a secure web site 15. The backend system 7 includes a web server module 17 that stores and serves web pages of the secure web site 15 to a web browser 19 on the computer 3 and/or mobile handset 5, as is known in the art. The registered user can log-in to the secure web site 15 and elect to register for a new product or service, such as the mobile application 9 provided by the backend system 7 for facilitating transactions with the associated financial institution via the mobile handset 5. It will be appreciated that the transactions may involve financial transaction based services, such as mobile online banking, P2P payment transactions, online shopping transactions, mobile wallet payments, etc.

The backend system 7 includes a registration module 21 that communicates with the computer 3 and the mobile handset 5, for example via the web server module 17, to process a request from a registered user for a new product or service, such as the mobile application 9. The registration module 21 registers the user for the new product or service after verifying the identity of the registered user associated with the request using an authentication module 23, which communicates data with the computer 3 and the mobile handset 5 to verify the identity of the user during the registration process. The authentication module 23 generates a security code 25 and a challenge code 27 for the registration session, using security code generator 29 and challenge code generator 31 modules, respectively. The generated security code 25 and challenge code 27 for the registration session are stored as data 28 in a secure database 33 of the backend system 7.

The database 33 also stores profile data 35 associated with registered users of the system, including for each registered user, a unique mobile directory number (MDN) 37 (or a Mobile Identification Number, MIN) associated with the user's mobile handset 5 and a confidential personal code 39 of the registered user. The user's profile data may also include log-in details (not shown) such as a username and password for accessing the secure web site 15 of the backend system 7. As is known in the art, the user's MDN 37 and log-in details may be provided during initial registration by the user for an account with the associated financial institution, and the confidential personal code 39 is typically a four or five digit Personal Identification Number (PIN) that may be assigned by the backend system for the user and the account. It will be appreciated that the user's personal code 39 can only be altered via secure channels that are external to the described modules of the present embodiment. Moreover, the personal code is not transmitted in any form during the registration and authentication processes of the present embodiment, thus shielding the confidential personal code from fraudulent activity in relation thereto.

The registration module 21 in the backend system 7 completes the registration process for the requested online product or service to the registered user after the user's identity has been verified by a response code verifier module 41 in the authentication module 23. As will be described in more detail below, the response code verifier module 41 determines whether the received response code matches a derived code 43 based on the security code and challenge code generated by the authentication module in combination with the user's confidential personal code.

Additional modules (not shown) may be provided in the backend system 9 to facilitate communication of data over the data network 11 and cellular network 13, and the provision of the online products and services, as well as other types of functionality that are known per se in such systems and need not be described further.

User Authentication Process

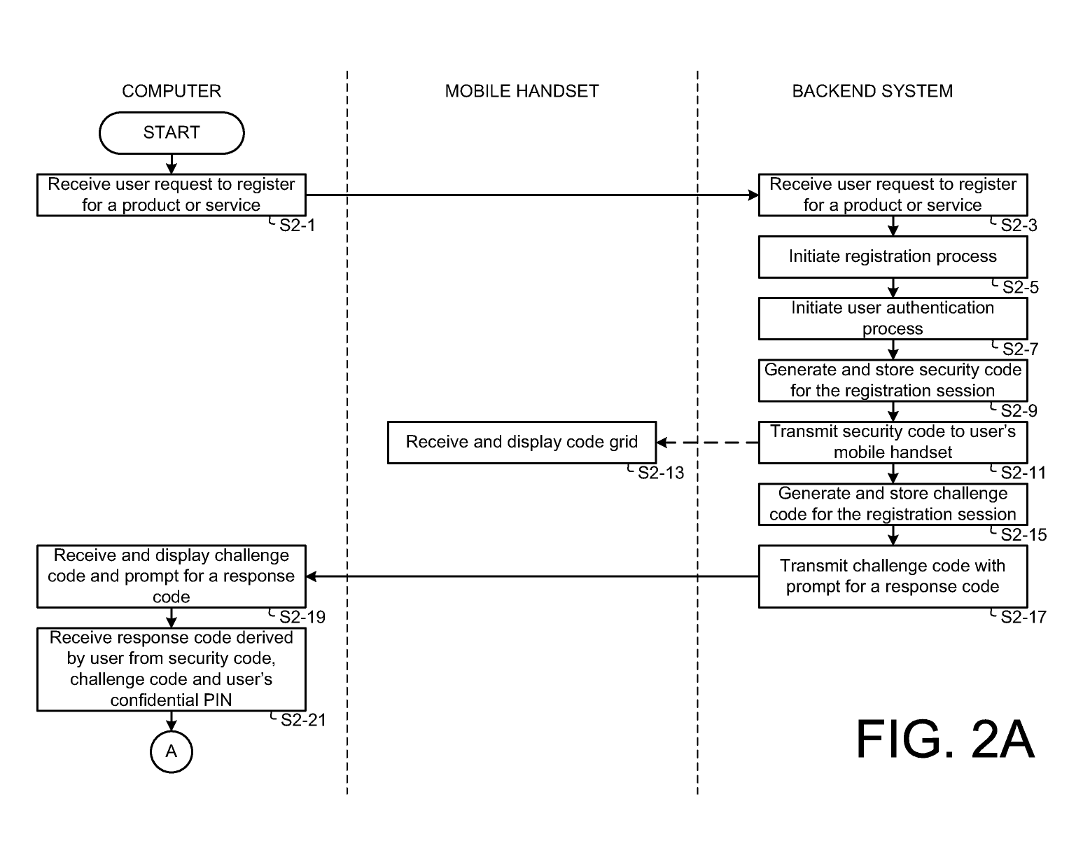

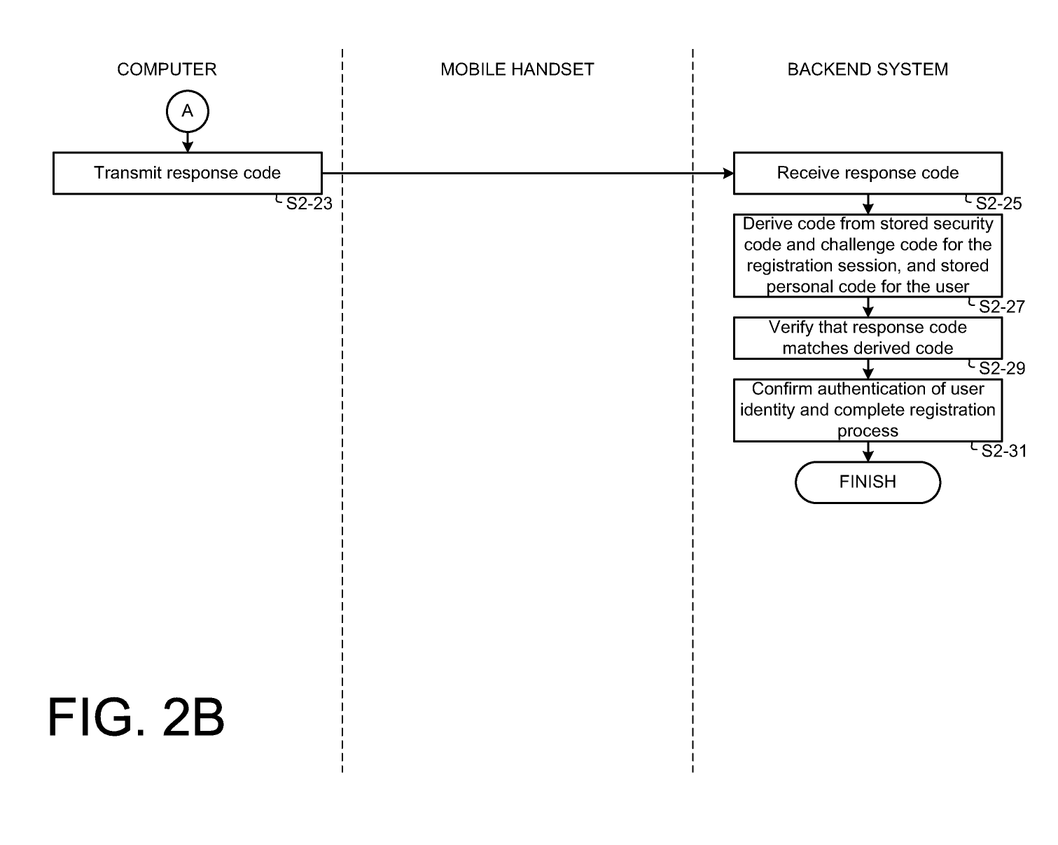

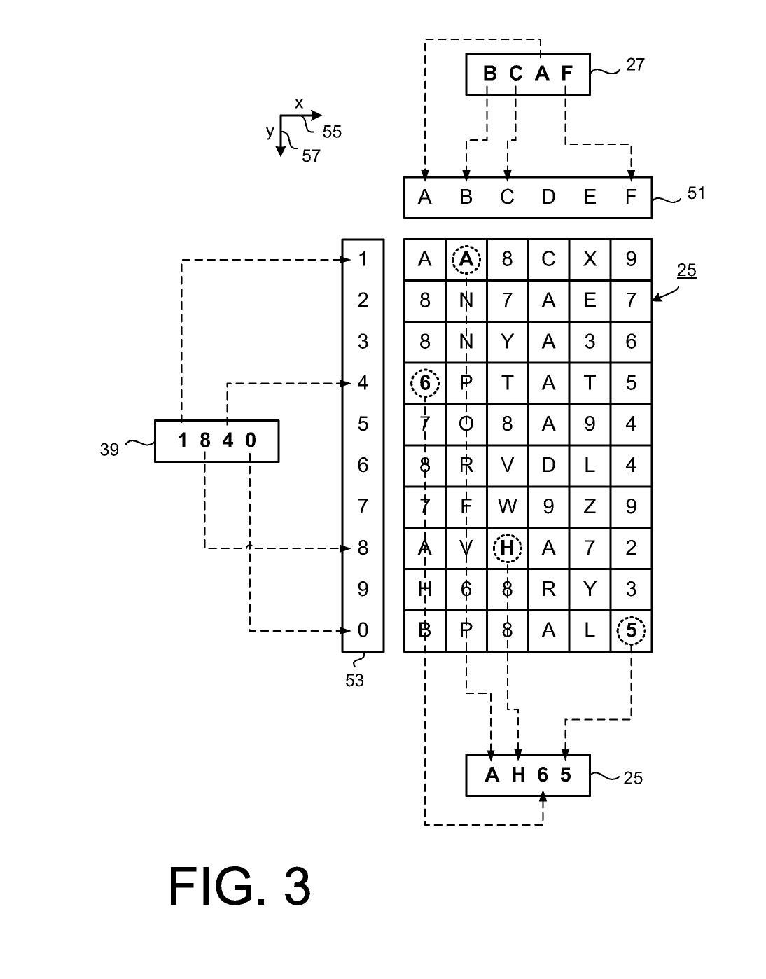

A brief description has been given above of the components forming part of the authentication system 1 of this embodiment. A more detailed description of the operation of these components in this embodiment will now be given with reference to the flow diagrams of FIG. 2, for an example computer-implemented user authentication process using the authentication module in the backend system. Reference is also made to FIG. 3, schematically illustrating an example of deriving a verification response code from the security code and challenge code generated by the authentication module in combination with the user's confidential personal code.

In this exemplary embodiment, the user authentication process is described in the context of registration, by the user via the web browser 19a on the computer 3, for an online product or service provided by the backend system 7 to the user's mobile handset 5. As discussed above, the user is pre-registered with the backend system 7 associated with a financial institution providing the requested product or service, and the backend system 7 securely stores profile data 33 for the registered user. The secure web site 15 of the backend system 7 enables the registered user to browse available online products and services and to select one or more desired products and services for registration. Additionally or alternatively, the user may be provided with a direct link to a web page for registration of a particular product or service.

As shown in FIG. 2, the process begins at step S2-1 where the computer 3 receives the user request to register for a product or service via a web page of the secure web site 15 displayed by the web browser 19a. At step S2-3, the backend system 7 receives the user request via the web server module 17 and in response initiates the registration process by the registration module 21 for the requested product or service at step S2-5, including initiation of a user authentication process by the authentication module 23 at step S2-7. The authentication module 23 processes user authentication for the registration process by generating and providing a security code 25 and a challenge code 27 to the user, and confirms the user's identity after verifying a response code received from the user that is derived from the generated security code 25 and challenge code 27, in combination with the user's confidential personal code 39 that is known to the user and is not transmitted by the backend system 7 during the registration and authentication process.

Accordingly, at step S2-9, the security code generator 29 of the authentication module 23 generates a security code 25 for the present registration session and stores the generated security code 25 in the database 33. In this embodiment, the security code 25 is a code grid composed of alphanumeric code elements arranged as a two-dimensional array. FIG. 3 illustrates an example of a code grid 25 generated by the security code generator 29 of the present embodiment. As shown in FIG. 3, the code grid elements of the array 25 are addressable by a first set of indices 51 along one axis and by a second set of indices 53 along the other axis.

The elements of the code grid may be pseudo-randomly generated by the security code generator 29, based for example on any known algorithm for generating a sequence of numbers and characters that approximates the properties of random numbers and characters. As an alternative, the elements of the code grid may be alphanumeric strings, words or images, which can be pseudo-randomly selected by the security code generator 29 from a predefined dictionary or list. Optionally, the security code generator 29 may include one or more security features in the generated security code. For example, the code grid may include additional repeating characters to avoid shoulder surfing and Trojan interception. As another example, ambiguous code elements may be removed from the code grid and replaced by non-ambiguous code elements. Code elements may be classified as ambiguous if the visual appearance of the alphanumeric character is substantially similar in appearance to any other alphanumeric character used in the code grid, and thus susceptible to misreading by the user. For example, the code elements “8” and “B” may be considered ambiguous. Likewise, the code elements “1 and L”, and “0” and “0” may be considered ambiguous.

At step S2-11, the backend system 7 transmits the generated security code 25 to the user's mobile handset 5. In this embodiment, the security code is transmitted to the mobile device in a Short Messaging System (SMS) format, as is known in the art. As discussed above, the MDN of the user's mobile handset 5 is known to the backend system 7 and can be retrieved from the profile data 33 associated with the registered user. At step S2-13, the mobile handset 5 receives the SMS and displays the security code to the user.

At step S2-15, the authentication module 23 continues the authentication process by generating a challenge code 27 for the present registration session and storing the generated challenge code 27 as additional registration session data 28 in the database 33. As will be described below, the challenge code 27 relates to the security code 25 generated at step S2-9, and includes a linear sequence of index elements selected from the first set of indices 51 for addressing the array of elements in the security code 25. In this embodiment, the challenge code is the same length as the personal code, thereby simplifying the process of addressing the two-dimensional array of elements in the security code, as will be described in more detail below. It will be appreciated that the authentication module 23 may generate the security code 27 after or substantially in parallel with the challenge code 29. Optionally, the security code 27 and/or challenge code 29 may be encrypted in accordance with the encryption standard protocols prior to transmission and storage.

At step S2-17, the backend system 7 transmits the generated challenge code 27 to the computer 3. In this embodiment, the challenge code 27 is transmitted to the computer 3 as web page data for display on the web browser 19a, the web page including a prompt for the user to enter a response code to complete the authentication process. At step S2-19, the computer 3 receives and displays the received challenge code and the prompt for the user to enter a response code. At step S2-21, the computer 3 receives a response code input by the user, derived by the user from the security code 25, the challenge code 27 and the personal code that is secretly known by the user. The user can enter the response code via the displayed web page, for example in an input text box or boxes. Alternatively, a plurality of user-selectable images associated with candidate response code elements may be presented to the user, whereby the user can respond to prompts for the derived response code elements via selection of the appropriate image.

The sequence of elements that constitute the response code 6 are retrieved by the user from elements of the received security code 25 located at coordinates of the two dimensional array defined by the sequential combination of characters from the challenge code 27 and numbers from the security code 25 at respective positions in the respective linear arrays. Each of the characters of the challenge code 27 are associated, in positional order, with each of the characters of the user personal code 39 to create a respective set of coordinates. The sequence of coordinates define respective addresses of the two-dimensional array of elements, forming the resulting response code 6. In this embodiment, the response code has the same character length as both the challenge code 25 and the user personal code 39.

Referring to the example illustrated in FIG. 3, the code grid 25 is indexed 51 by the characters of the generated challenge code 27 along the x-axis 55 and is indexed 53 by the numerical digits of the user's personal code 39 along the y-axis 57. In particular, the example generated challenge code 27 is a linear sequence consisting of the four characters “BCAF”, corresponding to the second, third, first and sixth columns of the code grid 25, in order. The example user personal code 39 is “1840”, corresponding to the first, eighth, fourth and tenth rows of the code grid, in order. As illustrated by the dashed lines in FIG. 3, the sequence of pairs of coordinates that are used to retrieve the response code are: (“B”: second column, “1”: first row), (“C”: third column, “8”: eighth row), (“A”: first column, “4”: fourth row) and (“F”: sixth column, “0”: tenth row), corresponding to the respective elements “A”, “H”, “6” and “5”, thus forming the response code “AH65”.

Referring back to FIG. 2, at step S2-23, the computer 3 transmits the user input response code to the authentication module 23 of the backend system 7, via the web server module 17, where it received by the response code verifier 41 at step S2-25. At step S2-27, the response code verifier 41 derives a corresponding code 43 for present registration session, based on the security code 25 and challenge code 27 stored in the registration session data 28, and the personal code 39 associated with the registered user stored in the user's profile data 35. In this embodiment, the response code verifier 41 is configured to automatically derive the code in a similar manner to the process carried out by the user at step S2-21.

At step S2-29, the response code verifier 41 verifies that the received response code matches the code derived at step S2-27. At step S2-31, the authentication module 23 confirms authentication of the user's identity after the response code verifier 41 determines that the received response matches the derived code 43, and proceeds to complete the registration process for the requested online product or service.

It will be appreciated that as an alternative, the registration module 21 may be configured to authenticate the user's identity via the authentication module 23 before enabling access by the registered user to download, install and use the mobile application 9 on the mobile handset 5.

In this way, the authentication system is adapted to include components that provide a more robust technique for verifying that the user is an authorized and registered user of the system before providing and/or enabling a requested product or service. The improved authentication technique advantageously increases the complexity of the “possession” factor in the two-factor, two-channel authentication mechanism, thereby reducing the risk of malicious activity, for example resulting from fraudulent access to the user's mobile handset.

### Computer Systems

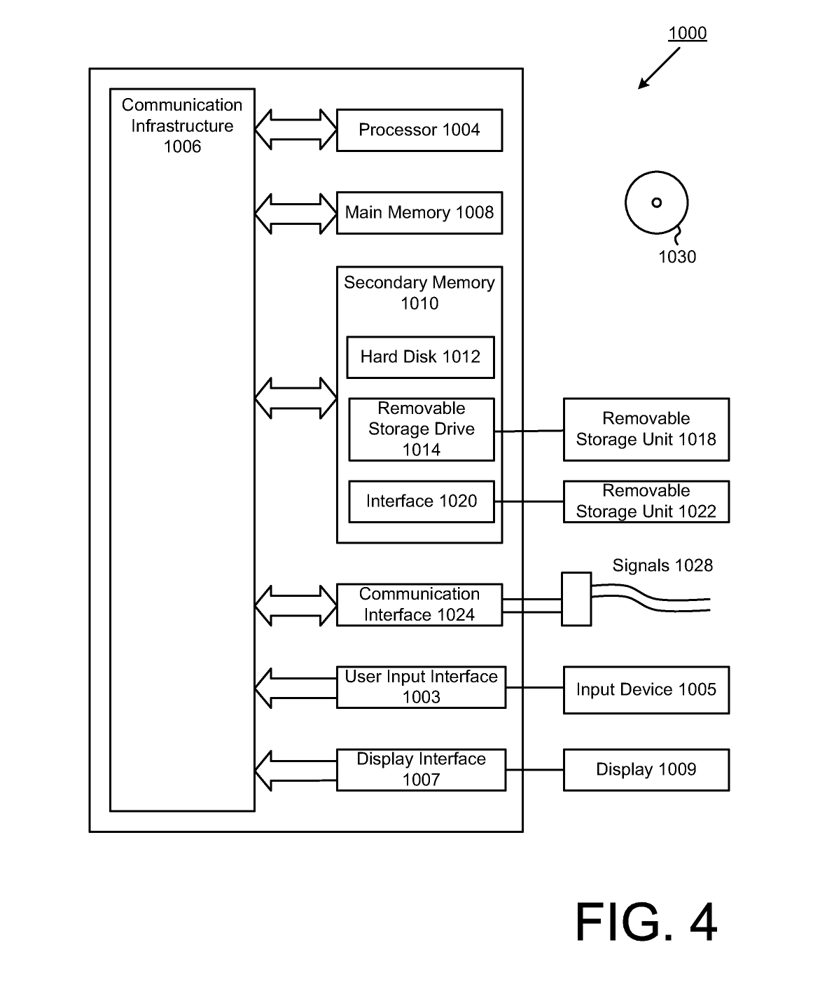

The entities described herein, such as the computer 3 and the backend system 7, may be implemented by computer systems such as computer system 1000 as shown in FIG. 4. Embodiments of the present invention may be implemented as programmable code for execution by such computer systems 1000. After reading this description, it will become apparent to a person skilled in the art how to implement the invention using other computer systems and/or computer architectures.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a user input interface 1003 connected to one or more input device(s) 1005 and a display interface 1007 connected to one or more display(s) 1009. Input devices 1005 may include, for example, a pointing device such as a mouse or touchpad, a keyboard, a touchscreen such as a resistive or capacitive touchscreen, etc. After reading this description, it will become apparent to a person skilled in the art how to implement the invention using other computer systems and/or computer architectures, for example using mobile electronic devices with integrated input and display components.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 1018 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product 1030 and loaded into computer system 1000 using removable storage drive 1014, hard disk drive 1012, or communication interface 1024, to provide some examples.

Alternative embodiments may be implemented as control logic in hardware, firmware, or software or any combination thereof.

### Alternative Embodiments

It will be understood that embodiments of the present invention are described herein by way of example only, and that various changes and modifications may be made without departing from the scope of the invention.

For example, in the embodiment described above, the computer and mobile handset are provided as separate devices and the user accesses the secure web site of the backend system via a web browser on the computer. It will be appreciated that as an alternative, a separate computer is not required and the user may instead access the secure web site via the web browser on the mobile handset, to request and register for a product or service as described in the embodiment above.

In the embodiment described above, the security code is transmitted by the backend server to the mobile handset in an SMS format. Alternatively or additionally, the security code can be transmitted to a mobile application on the mobile handset, for example via the data network. In such an alternative, the user may be required to enter a PIN or passcode to access the mobile application in order to view the received security code, thereby adding yet another layer of complexity to the “possession” authentication factor, requiring the inherent user possession of his or her mobile handset at the time of verification.

In the embodiment described above, the generated code grid is a two-dimensional array of elements, indexed by the user's personal code along one axis and the received challenge code along the other axis. As those skilled in the art will appreciate, the generated security code could comprise more than two dimensions, and indexed by a corresponding number of sensitive data entities.

In the embodiment described above, the authentication module generates and provides an alphanumeric security code that is indexed by a numerical personal code and a challenge code consisting of alphabetic characters. It will be appreciated that the security code, the personal code and the challenge code may take any known corresponding form, such as an alphabetic, numeric or symbolic passcode, or a combination thereof, and may be of any length. As yet a further modification, the code elements of the challenge code may be further encoded or rendered by the challenge code generator to an image or audio file format. In this way, the code elements of the challenge code are advantageously obfuscated for transmission. In such a modification, the user's computing device may be adapted to decode the received image or audio file to retrieve the code elements of the challenge code for addressing the security code as described in the embodiment above.

In the embodiment described above, the backend system is configured to confirm the identity of a registered user and to provide a mobile application that facilitates financial transaction based services between the mobile handset and the financial institution associated with the backend system. It will be appreciated that alternatively or additionally, the authentication process as described in the above embodiment can be implemented as part of the user log-in or log-on process to access products and services provided by the backend system to registered users. Additionally, the backend system may be arranged to facilitate online transactions that are not necessarily financial in nature, such as online account management for registered services, online database access, etc. In such an alternative, the backend system may not be associated with a financial institution as described in the embodiment above.

In the embodiment described above, a web server module is provided as a component of the backend system. As those skilled in the art will appreciate, part or all of the secure web site may be hosted by a web server external to the backend system, for example by a third party system in communication with the backend system.

In the embodiment described above, the user is prompted to enter a response code derived from the received security code and challenge code, in combination with the confidential personal code. As those skilled in the art will appreciate, the user's computing device may instead be configured to receive the user's personal code and to automatically derive the response code from the received code grid as described, before transmitting the automatically derived response code to the backend system for verification.

In the embodiment described above, the challenge code and the personal code are of the same length, defining a sequence of pairs of coordinates for addressing the array of elements of the security code to derive the response code. As those skilled in the art will appreciate, it is not necessary for the response code verifier module to have direct knowledge of the user's secret personal code. As an alternative, the backend system can be configured to store the personal code in a one-way hashed form, whereby the response code verifier module can validate the response code using the stored hashed personal code. In such an alternative, the server-side implementation of the response code verifier can be adapted to take the received response code and to generate all possible combinations of coordinates. From the set of all possible coordinate combinations, the response code verifier can calculate candidate personal codes and calculate a one-way hash of each candidate personal code. If any match, then the response code verifier can confirm that the received response code was derived based on the secret personal code. Whilst this alternative implementation reduces the overall entropy, it is advantageously more difficult for a fraudster to observe the system and data transmissions to deduce the actual personal code.

As yet another alternative, the authentication module can be further modified to provide the user with a selection of challenge characters of potentially arbitrary length. Using the above hash and candidate personal code alternative technique, the response code verifier can find a match. Order could also play a factor (or not) in the challenge characters. Further, a zero challenge may also be possible for some scenarios where the authentication module can instead simply request input of particular, random, characters from rows of the secret personal code. It will be appreciated that each variation to the authentication process will have an impact on the overall system entropy, susceptibility to shoulder surfing and usability, resulting in different security integrity that may or may not be suitable for a given service access.

In the embodiment described above, the backend system includes a plurality of functional modules in memory, which when executed, enable the system to implement the embodiments as discussed herein. As those skilled in the art will appreciate, the modules may be provided as computer programs or software, and the software may be stored in a computer program product and loaded into the system using any known instrument, such as removable storage disk or drive, hard disk drive, or communication interface, to provide some examples. Additionally, although the backend system is illustrated as a single component within the authentication system for clarity, it will be appreciated that the backend system may be implemented as a plurality of distributed components for increased efficiency, security and robustness.

Alternative embodiments may be envisaged, which nevertheless fall within the scope of the following claims.

1. A computer-implemented method for authenticating the identity of a user registered with a computer system, the method comprising:
storing data representative of a personal code associated with the registered user;
generating a multi-dimensional array of elements comprising at least a first set of indices for addressing the array in a first direction and a second set of indices for addressing the array in a second direction;
generating a challenge code comprising a linear array of elements, each element corresponding to an index in the first set of indices;
transmitting the multi-dimensional array of elements and challenge code to at least one computing device associated with the user;
receiving a response code from a computing device associated with the user;
comparing the received response code to a derived code obtained by retrieving elements from the multi-dimensional array at locations addressed by elements taken from the challenge code and the personal code, wherein the personal code comprises a linear array of elements corresponding to an index in the second set of indices; and
authenticating the identity of the user when the response code matches the derived code.

2. The method of claim 1, wherein:
the generated array of elements is a two-dimensional array, the challenge code defines a sequence of columns of the multi-dimensional array, and the response code defines a sequence of rows of the multi-dimensional array; and
the derived code is obtained by retrieving elements from the multi-dimensional array at locations addressed by respective columns and rows defined by elements taken from the challenge code and the personal code in positional order.

3. The method of claim 1, wherein the computer system stores and transmits the multi-dimensional array of elements and challenge code as encrypted and/or algorithmically-encoded data.

4. The method of claim 1, wherein the multi-dimensional array of elements comprises numeric, alphabetic, alphanumeric or non-alphanumeric symbols, words or images.

5. The method of claim 1, wherein the multi-dimensional array of elements is transmitted to a user's mobile handset and the challenge code is transmitted to a user's computing device.

6. The method of claim 5, wherein the multi-dimensional array of elements is transmitted over a first communication channel and the challenge code is transmitted over second, communication channel different to the first communication channel.

7. The method of claim 6, wherein the generated multi-dimensional array of elements is transmitted to a user's mobile handset as an SMS message over a cellular data network, and wherein the challenge code is transmitted to the user's computing device as a web page prompting the user for a response code.

8. The method of claim 1, wherein the personal code and the challenge code are the same length.

9. The method of claim 1, wherein the personal code, security code and challenge code comprise numeric, alphabetic, alphanumeric or non-alphanumeric symbols.

10. The method of claim 1, wherein the elements of the challenge code are encoded to an image or audio file format for transmissions to the user's computing device.

11. The method of claim 1, wherein the computing device receives the personal code input by the user and derives the response code based on the received multi-dimensional array of elements, challenge code and personal code.

12. The method of claim 1, further comprising:
receiving, at the backend system, a request from a computing device for an online transaction by the registered user; and
processing the online transaction after authenticating the identity of the registered user.

13. The method of claim 12, wherein the online transaction is to download and/or activate a software application to the user's computing device.

14. A computer-implemented method for authenticating the identity of a user associated with a mobile handset at a host computer, the method comprising:
generating and transmitting a security code and a challenge code to the user, the security code comprising a multi-dimensional array of code elements and the challenge code defining a plurality of elements for addressing the array of code elements along a first axis; and
receiving and verifying a response code from the user, by matching the response code to a code derived by the host computer based on the generated security code and challenge code in combination with a personal code stored at the host computer, wherein each element of the challenge code is associated, in positional order, with an element of the personal code to define a respective set of coordinates to the multi-dimensional array of code elements for retrieving the elements of the derived code.

15. A system comprising means for performing the method of claim 1.

16. A storage medium comprising machine readable instructions stored thereon for causing a computer system to perform a method in accordance with claim 1.

17. A system comprising means for performing the method of claim 14.

18. A storage medium comprising machine readable instructions stored thereon for causing a computer system to perform a method in accordance with claim 14.
